(19) United States
(12) Patent Application Publication
(10) Pub. No.: US 2020/0167440 A1
(43) Pub. Date: May 28, 2020

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Eiji Yajima, Kawaguchi-shi (JP); Naoto Okutani, Yokohama-shi (JP)

(21) Appl. No.: 16/685,416

(22) Filed: Nov. 15, 2019

(30) Foreign Application Priority Data
Nov. 22, 2018 (JP) 2018-219422

(51) Int. Cl. G06F 17/50

(52) U.S. Cl. CPC G06F 17/5009; G06F 2217/80

(57) ABSTRACT

An information processing apparatus determines internal/external surface information indicating whether each surface of a structure specified by structure data is internally exposed on the stricture or externally exposed on the structure based on a form coefficient. The information processing apparatus performs a thermal analysis on the structure based on the internal/external surface information and the form coefficient.

### BACKGROUND

### Field

The present disclosure relates to an information processing apparatus that performs a thermal analysis including a thermal analysis of convection.

### Description of the Related Art

Reduction in size and increase in integration of a structure such as an electronic device have necessitated a thermal analysis in a designing process. One of calculation methods of the thermal analysis is a thermal network method, which is widely known. The thermal network method is a method in which an analysis target component is divided into relatively rough regions, a node is provided to each region, and a simultaneous equation about each node is solved using a heat flow as a conserved quantity. With the thermal network method, a result is obtained by smaller-scale calculation processing than that in a calculation method, such as a finite element method in which an analysis target is divided into small regions and a behavior of a fluid is analyzed in detail. Using this advantage, the thermal network method is known as an effective method for thermal study in early stage of a designing process.

In connection with the thermal network method, Japanese Patent Application Laid-Open NO. 4-7675 discusses a technique in which a thermal network and a fluid network are generated by generating a rough mesh in a component and a fluid space using a computer-aided design (CAD) model generated using CAD.

Further, in connection with a display of a thermal analysis result, Japanese Patent Application Laid-Open No. 2006-350504 discusses a method in which not a temperature distribution or heat flux but an amount of heat transferred between components is calculated and the calculation result is displayed in order to perform heat-release designing in a short period of time without repeated calculations.

At the time of generating a thermal network model of a structure, whether each surface of the structure is internally exposed on the structure or externally exposed on the structure needs to be identified, because a convection heat resistance differs depending on whether the surface is exposed internally or externally.

Conventionally, whether a surface is internally or externally exposed on a structure has been visually identified on a CAD model by a user. This operation is extremely burdensome and, further, input mistakes often occur.

### SUMMARY

According to an aspect of the present disclosure, an information processing apparatus configured to perform a thermal analysis including a thermal analysis of convection includes a derivation unit configured to derive a form coefficient based on structure data, a first determination unit configured to determine, based on the form coefficient, surface information indicating whether each surface of a structure specified by the structure data taken as is internally exposed on the structure or externally exposed on the structure, and a thermal analysis unit configured to perform the thermal analysis on the structure based on the surface information and the form coefficient.

Further features of the present disclosure will become apparent from the following description of exemplary embodiments with reference to the attached drawings.

### BRIEF DESCRIPTION OF THE DRAWINGS

FIGS. 1A, 1B, and 1C illustrate a structure and components.

FIGS. 2A, 2B, and 2C illustrate a principle.

FIGS. 3A, 3B, 3C, and 3D illustrate shape data on a structure and a thermal network model.

FIG. 4 illustrates an example of hardware of an information processing apparatus.

FIG. 5 is a functional block diagram.

FIG. 6 is a flowchart corresponding to an information processing method.

### DESCRIPTION OF THE EMBODIMENTS

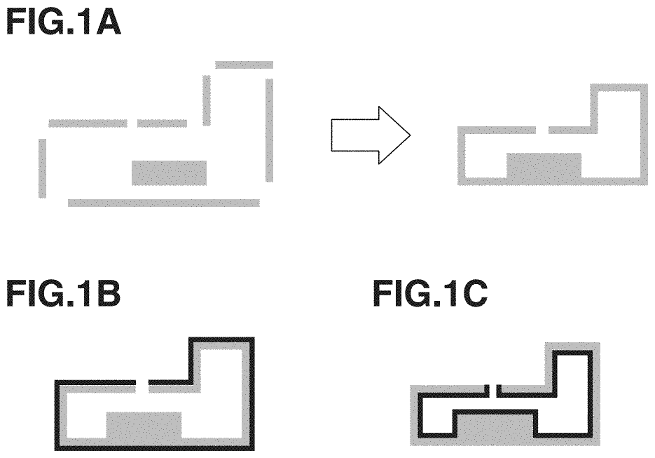

FIGS. 1A to 1C illustrate a structure and components according to an exemplary embodiment of the present disclosure.

A drawing on the left hand side of FIG. 1A illustrates individual components that form a structure. A structure on the right hand side of FIG. 1A is formed from the plurality of components illustrated on the left hand side of FIG. 1A by a structure editing unit (editing unit that uses computer-aided design (CAD)), which will be described below. The structure is, for example, a housing of a camera or printer. Inside the structure, there are a heat generation unit, such as a central processing unit (CPU) and a fixing unit, and a cooling unit, such as a fan and a fin. A thermal analysis according to the present exemplary embodiment is performed on the structure including the inside components.

At the time of performing a thermal analysis including a thermal analysis of convection on the structure, whether each surface of the structure is internally exposed on the structure or externally exposed on the structure needs to be judged. In general, an externally-exposed surface (hereinafter, referred to as “external surface”) is a region that is in direct contact with outside air, and thus easily loses heat due to convection. On the other hand, an internally-exposed surface (hereinafter, referred to as “internal surface”) is a region that is not in direct contact with outside air, thus does not easily lose heat due to convection.

Each dark surface of the structure in FIG. 1B is an external surface, and each dark surface of the structure in FIG. 1C is an internal surface.

An upper side of the structure has a hole In a case where a condition of the judgement of whether a surface is an external surface or an internal surface is “whether the surface is outside or inside a closed space”, the dark surfaces in FIGS. 1B and 1C are both external surfaces. However, in the case of performing a thermal analysis including a thermal analysis of convection, the dark surface in FIG. 1C is to be taken as an internal surface. Conventionally, whether a surface is an external surface or an internal surface has been visually judged based on user experiences. This operation is extremely burdensome and, furthermore, errors due to user's mistakes often occur.

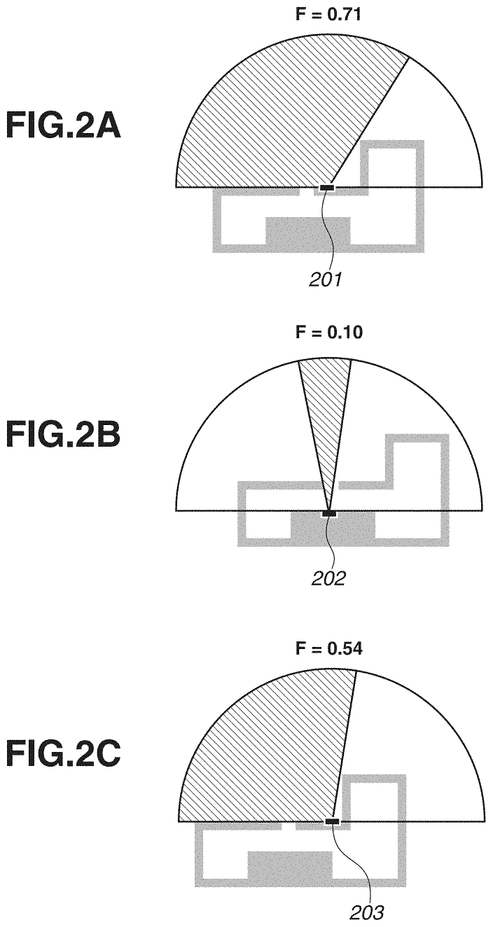

FIGS. 2A to 2C illustrate a principle in the present exemplary embodiment. method of judging whether a facet 201 in FIG. 2A and a facet 202 in FIG. 2B are an internal surface or an external surface (hereinafter, the method will be referred to as “internal/external surface judgement”) will be described below.

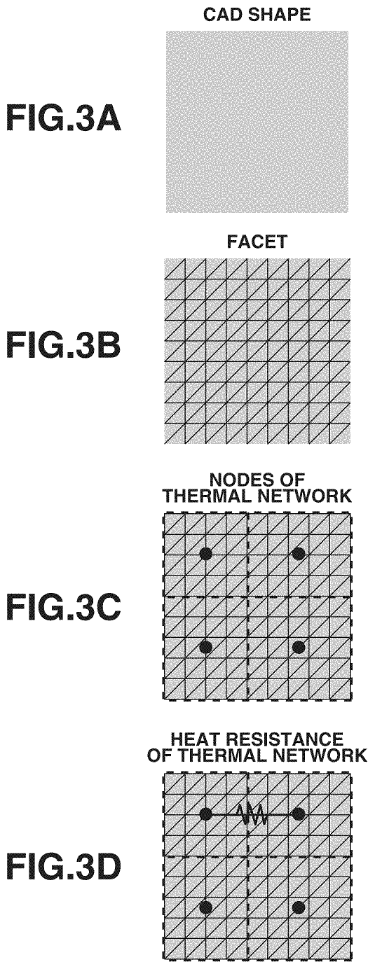

There is a square structure (CAD shape) as illustrated in FIG. 3A. FIG. 3B illustrates a structure divided into facets (triangles). The internal/external surface judgement is to be performed on the facets. In a thermal analysis described below, analysis using a thermal network is performed. Each black point in FIG. 3C represents a node in the thermal network. FIG. 3D schematically illustrates a resistance in the thermal network.

In a case of performing a thermal analysis using a thermal network model, a form coefficient F is used. The form coefficient F is needed in gene model of radiation. In the present exemplary embodiment, the internal/external surface judgement on the structure is performed using the form coefficient F.

The form coefficient F with respect to a wall surface or an infinite distance that specifies a calculation region of each face is obtained. The internal/external surface judgement on the structure is performed by comparing the form coefficient and a threshold value TH.

F>TH Formula 1

F<TH Formula 2

In a case where Formula 1 is satisfied, it is judged that the facet is an external surface of the structure, whereas in a case where Formula 2 is satisfied, it is judged that the facet is an internal surface of the structure.

In a case where the threshold value TH is zero, whether the structure is completely sealed is judged. The threshold value TH is determined by the user based on the properties of the structure and an environment. In a case where a less-experienced user is to determine the threshold value TH or the threshold value TH for a new structure is to be determined, the threshold value TH can be determined using artificial intelligence with previous data as teaching data to determine the threshold value TH as appropriate.

In a case where the threshold value TH is set to 0.6, it is judged that the facet 201 in FIG. 2A is an external surface and the facet 202 in FIG. 2B is an external surface.

As described above, in the present exemplary embodiment, the internal/external surface judgement on the structure is performed using the form coefficient F, which is used in a thermal analysis.

### <Hardware>

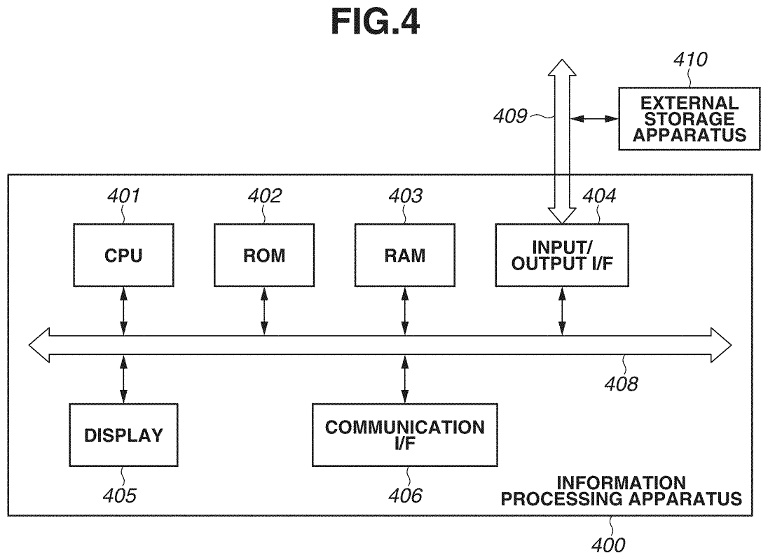

FIG. 4 illustrates an example of hardware of an information processing apparatus 400 for the thermal analysis of the structure in the present exemplary embodiment.

The information processing apparatus 400 is realized by a device, such as a personal computer (PC), that has a communication function. The information processing apparatus 400 includes a CPU 401, a read-only memory (ROM) 402, a random access memory (RAM) 403, an input/output interface (I/F) 404, a display 405, and a communication I/F 406, The CPU 401 executes an operating system (OS) and various programs stored in the ROM 402 or an external storage apparatus 410 using the RAM 403 as a work memory. Further, the CPU 401 controls each configuration via a system bus 408. A program code stored in the ROM 402 or the external storage apparatus 410 is developed to the RAM 403, and the CPU 401 executes the developed program code to thereby realize a process illustrated in a flowchart described below. The external storage apparatus 410 is connected to the input/output I/F 404 via a serial bus 409. The external storage apparatus 410 is a solid state drive (SSD) or a hard disk drive (HDD). The display 405 is a display device that displays a thermal analysis result.

### <Information Processing Apparatus>

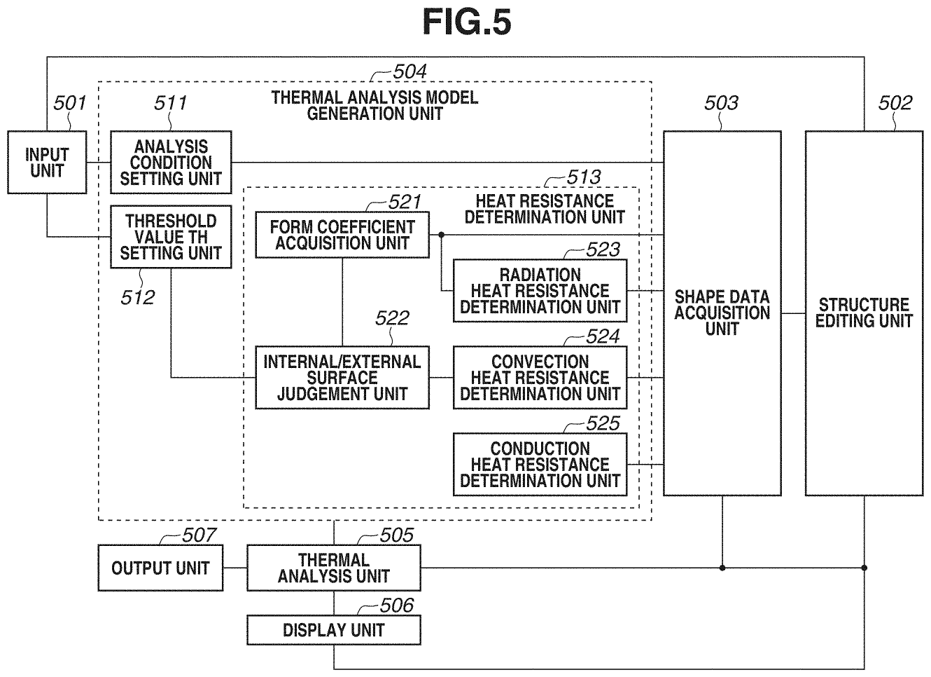

FIG. 5 is a functional block diagram illustrating the information processing apparatus 400. The CPU 401 of the information processing apparatus 400 executes a program stored in the ROM 402 using the RAM 403 as a work memory to thereby realize a function illustrated in FIG. 5. The entire processing described below does not necessarily have to be executed by the CPU 401, and the information processing apparatus 400 can be configured in such a manner that the processing is partially or entirely executed by a single processing circuit or a plurality of processing circuits other than the CPU 401.

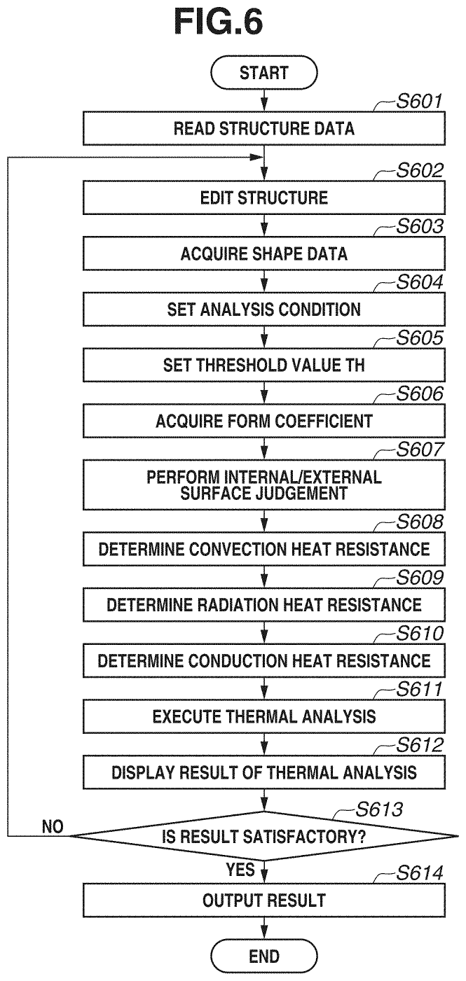

The information processing apparatus 400 includes an input unit 501, a structure editing unit 502, a shape data acquisition unit 503, a thermal analysis model generation unit 504, a thermal analysis unit 505, a display unit 506, and an output unit 507. The thermal analysis model generation unit 504 includes an analysis condition setting unit 511, a threshold value TH setting unit 512, and a heat resistance determination unit 513. The heat resistance determination unit 513 includes a form coefficient acquisition unit 521, an internal/external surface judgement unit 522, a radiation heat resistance determination unit 523, a convection heat resistance determination unit 524, and a conduction heat resistance determination unit 525. Each unit functions to realize an information processing method illustrated in FIG. 6.

### <Information Processing Method>

FIG. 6 is a flowchart corresponding to an information processing method according to the present exemplary embodiment.

In step S601, the input unit 501 reads structure data (CAD data) via an external device or a network based on a user instruction. The structure data includes properties (shape and material) of components that form the structure and relations (position/orientation, connection, and tolerance) between the components.

In step S602, the structure editing unit 502. edits the structure data based on the user instruction.

In step S603, the shape data acquisition unit 503 acquires shape data about the structure. The shape data about the structure includes information about the facets and nodes of the structure in the subsequent steps.

In step S604, the analysis condition setting unit 511 sets an analysis condition based on the user instruction and input from an external device. The analysis condition includes an external environment (expected temperature and humidity during a thermal analysis) of the structure, material data about the structure, properties of a heat generation member, and a thermal analysis calculation step. The analysis condition can be included in the shape data about the structure.

In step S605, the threshold value TH setting unit 512 sets the threshold value TH based on the user instruction. The threshold value TEL can be automatically determined by reference to a previous input value.

In step S606, the form coefficient acquisition unit 521 acquires the form coefficient F for each facet. At this time, a form coefficient acquisition method that has been conventionally used in a thermal analysis including a thermal analysis of radiation can be used.

In step S607, the internal/external surface judgement unit 522 performs internal/external surface judgement on each facet and acquires internal/external surface information. In the internal/external surface judgement, the form coefficient F and the threshold value TH are used as described above in the section <Principle in the Present Exemplary Embodiment>. The form coefficient that has been conventionally used in a thermal analysis of radiation is used in the internal/external surface judgement in the present exemplary embodiment. The internal/external surface information indicates whether each surface of the structure specified by the structure data is internally exposed on the structure or externally exposed on the structure.

In step S608, the convection heat resistance determination unit 524 determines a convection heat resistance value between the nodes based on the internal/external surface information and the shape data.

In step S609, the radiation heat resistance determination unit 523 determines a radiation heat resistance value between the nodes based on the form coefficient F and the shape data.

In step S610, the conduction heat resistance determination unit 525 determines a conduction heat resistance value between the nodes based on the shape data.

In step S611, the thermal analysis using the thermal network model is performed based on the various heat resistance values and the shape data acquired by the thermal analysis model generation unit 504.

In step S612, the display unit 506 displays a result of the thermal analysis. The display unit 506 superimposes and displays a symbol (e.g., mesh) that represents a temperature on a display object that represents the structure in three-dimensional (3D) CAD. Further, the display unit 506 displays the internal/external surface information. The display unit 506 superimposes and displays a symbol that represents an internal/external surface on the object that represents the structure in the 3D CAD.

In step S613, the thermal analysis result displayed on the display unit 506 is checked, and whether a user-desired result is obtained is judged. This judgement can be automatically performed using artificial intelligence. In a case where the result is satisfactory (YES in step S613), the processing proceeds to step S614. Otherwise, the processing returns to step S602. Then, the internal/external surface information displayed on the display unit 506 is checked, and whether a user-desired result is obtained is judged again. In a case where the result is satisfactory (YES in step S613), the processing proceeds to step S614. Otherwise, the processing returns to step S602. Alternatively, the processing can return to step S604. Further, the judgement can be performed after step S607.

In step S614, the output unit 507 outputs the thermal analysis result or the internal/external surface information to an external device.

In step S613, in a case where the user is not satisfied (NO in step S613), a change is made to the editing of the structure data and/or the analysis condition. In a case where the user is not satisfied with the result of the internal/external surface judgement, the user resets the threshold value TH in step S604. For example, in a case where an initial value of the threshold value TH is set to 0.6, it is judged that a facet 203 in FIG. 2C is an internal surface. However, if the user wishes to set the facet 203 as an external surface, the threshold value TH is reset to a value less than 0.54 (e.g., TH=0.3) in step S604. As described above, in a case where the user is not satisfied with the internal/external surface judgement, the user simply changes the threshold value TH without manually inputting an “internal” or “external” flag with respect to the large number of facets.

As described above, in the present exemplary embodiment, the form coefficient that has been conventionally derived for the thermal analysis of radiation is used in the internal/external surface judgement used in the thermal analysis of convection, whereby the burden on the user is significantly reduced and user input errors are also reduced.

Further, the form coefficient acquisition unit 521 realizes a function of determining the form coefficient for the thermal analysis of radiation and a function of determining the form coefficient for the thermal analysis of convection. Specifically, in a case where any change is made to a form coefficient determination method, hardware and software corresponding to the form coefficient acquisition unit 521 are changed once so that the functions relating to the radiation and convection can be changed.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network. or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-219422, filed Nov. 22, 2018, which is hereby incorporated by reference herein in its entirety.

What is claimed is:

1. An information processing apparatus configured to perform a thermal analysis including a thermal analysis of convection, the information processing apparatus comprising:
a derivation unit configured to derive a form coefficient based on structure data;
a first determination unit configured to determine, based on the form coefficient, surface information indicating whether each surface of a structure specified by the structure data is taken as internally exposed on the structure or externally exposed on the structure; and
a thermal analysis unit configured to perform the thermal analysis on the structure based on the surface information and the form coefficient.

2. The information processing apparatus according to claim 1, further comprising a second determination unit configured to determine a convection heat resistance needed in the thermal analysis of convection on the structure based on the surface information,
wherein the thermal analysis unit performs the thermal analysis on the structure based on the convection heat resistance.

3. The information processing apparatus according to claim 2, further comprising a third determination unit configured to determine a conduction heat resistance needed in a thermal analysis of conduction on the structure,
wherein the thermal analysis unit performs the thermal analysis on the structure based on the convection heat resistance and the conduction heat resistance.

4. The information processing apparatus according to claim 2, further comprising a fourth determination unit configured to determine a radiation heat resistance needed in a thermal analysis of radiation on the structure based on the form coefficient,
wherein the analysis unit performs the thermal analysis on the structure based on the convection heat resistance and the radiation heat resistance or based on the convection heat resistance, the conduction heat resistance, and the radiation heat resistance.

5. The information processing apparatus according to claim 1, wherein the first determination unit determines the surface information by comparing the form coefficient and a threshold value, the surface information indicating whether each surface of the structure specified by the structure data is taken as internally exposed on the structure or externally exposed on the structure.

6. The information processing apparatus according to claim 5, further comprising an input unit configured to input the threshold value.

7. The information processing apparatus according to claim 1, further comprising a display unit configured to display a result of the thermal analysis.

8. The information processing apparatus according to claim 7, wherein the display unit displays, on a display object that represents the structure, a symbol relating to the surface information in a superimposed manner.

9. The information processing apparatus according to claim 7, further comprising a changing unit configured to receive a change to the threshold value from a user after the display unit displays the surface information or the result of the thermal analysis,
wherein the first determination unit determines the surface information based on the changed threshold value, and
wherein the thermal analysis unit performs the thermal analysis on the structure.

10. An information processing method of performing a thermal analysis including a thermal analysis of convection, the method comprising:
deriving a form coefficient based on structure data;
firstly determining, based on the form coefficient, surface information indicating whether each surface of a structure specified by the structure data is taken as internally exposed on the structure or externally exposed on the structure; and
performing the thermal analysis on the structure based on the surface information and the form coefficient.

11. The information processing method according to claim 10, further comprising secondarily determining a convection heat resistance needed in the thermal analysis of convection on the structure based on the surface information,
wherein the thermal analysis is performed on the structure based on the convection heat resistance.

12. The information processing method according to claim 11, further comprising thirdly determining a conduction heat resistance needed in a thermal analysis of conduction on the structure,
wherein the thermal analysis is performed on the structure based on the convection heat resistance and the conduction heat resistance.

13. The information processing method according to claim 11, further comprising fourthly determining a radiation heat resistance needed in a thermal analysis of radiation on the structure based on the form coefficient,
wherein the thermal analysis is performed on the structure based on the convection heat resistance and the radiation heat resistance or based on the convection heat resistance, the conduction heat resistance, and the radiation heat resistance.

14. The information processing method according to claim 10, wherein the firstly determining determines the surface information by comparing the form coefficient and a threshold value, the surface information indicating whether each surface of the structure specified by the structure data is taken as internally exposed on the structure or externally exposed on the structure.

15. The information processing method according to claim 14, further comprising inputting the threshold value.

16. The information processing method according to claim 10, further comprising displaying a result of the thermal analysis.

17. The information processing method according to claim 16, wherein the displaying displays, on a display object that represents the structure, a symbol relating to the surface information in a superimposed manner.

18. The information processing method according to claim 16, further comprising receiving a change to the threshold value from a user after the displaying displays the surface information or the result of the thermal analysis,
wherein the firstly determining determines the surface information based on the changed threshold value, and
wherein the thermal analysis is performed on the structure.

19. A non-transitory storage medium storing a program causing a computer to execute an information processing method of performing a thermal analysis including a thermal analysis of convection, the method comprising:
deriving a form coefficient based on structure data;
firstly determining, based on the form coefficient, surface information indicating whether each surface of a structure specified by the structure data is taken as internally exposed on the structure or externally exposed on the structure; and
performing the thermal analysis on the structure based on the surface information and the form coefficient.

20. The non-transitory storage medium according to claim 19,
wherein the method further comprises secondarily determining a convection heat resistance needed in the thermal analysis of convection on the structure based on the surface information, and
wherein the thermal analysis is performed on the structure based on the convection heat resistance.
